(19) United States
(12) Patent Application Publication
(10) Pub. No.: US 2017/0342897 A1
(43) Pub. Date: Nov. 30, 2017

(54) VARIABLE LENGTH CONNECTING ROD AND VARIABLE COMPRESSION RATIO INTERNAL COMBUSTION ENGINE

(71) Applicant: TOYOTA JIDOSHA KABUSHIKI KAISHA, Toyota-shi, Aichi-ken (JP)

(72) Inventor: Shuichi EZAKI, Toyota-shi (JP)

(73) Assignee: TOYOTA JIDOSHA KABUSHIKI KAISHA, Toyota-shi, Aichi-ken (JP)

(21) Appl. No.: 15/538,415

(22) PCT Filed: Nov. 5, 2015
(86) PCT No.: PCT/JP2015/005561

§ 371 Date: Jun. 21, 2017

(30) Foreign Application Priority Data
Dec. 22, 2014 (JP) 2014-259424

(51) Int. Cl. F02B 75/04; F16C 23/10; F16C 7/06

(52) U.S. Cl. CPC F02B 75/045; F16C 7/06; F16C 23/10

(57) ABSTRACT

A variable length connecting rod includes: a connecting rod body; an eccentric member which can swivel with respect to the connecting rod body and in which the effective length of the variable length connecting rod is changed when swiveled; a first piston mechanism making the eccentric member swivel in one direction when hydraulic fluid is fed; a second piston mechanism making the eccentric member swivel in the opposite direction when hydraulic fluid is fed; and a flow direction changing mechanism switching flow directions of hydraulic fluid between the first and second piston mechanisms. The first piston mechanism and second piston mechanism are formed so that a first cylinder volume defined by a stroke length of the first piston and a cross-sectional area of the first cylinder is equal to a second cylinder volume defined by a stroke length of the second piston and a cross-sectional area of the second cylinder.

### CROSS-REFERENCE TO RELATED APPLICATIONS

This application is a national phase application of International Application No. PCT/JP2015/005561, filed Nov. 5, 2015, and claims the priority of Japanese Application No. 2014-259424, filed Dec. 22, 2017, the content of both of which is incorporated herein by reference.

### TECHNICAL FIELD

The present invention relates to a variable length connecting rod which can change in its effective length and a variable compression ratio internal combustion engine which is provided with a variable length connecting rod.

### BACKGROUND ART

Known in the past has been an internal combustion engine provided with a variable compression ratio mechanism which can change a mechanical compression ratio of the internal combustion engine. As such a variable compression ratio mechanism, various mechanisms have been proposed. As one among these, one which can change the effective length of a connecting rod used in the internal combustion engine may be mentioned (for example, PTLs 1-3). In this regard, the “effective length of a connecting rod” means the distance between a center of a crank pin receiving opening which receives a crank pin and a center of a piston pin receiving opening which receives a piston pin. Therefore, if the effective length of a connecting rod becomes longer, a combustion chamber volume when the piston is at top dead center of the compression stroke becomes smaller, and therefore the mechanical compression ratio increases. On the other hand, if the effective length of a connecting rod becomes shorter, the combustion chamber volume when the piston is at top dead center of the compression stroke becomes larger, and therefore the mechanical compression ratio falls.

As a variable length connecting rod which can be changed in effective length, known is one which is provided with a connecting rod body with a small end on which an eccentric member (eccentric arm or eccentric sleeve), which can swivel with respect to the connecting rod body, is provided (for example, PTLs 1 and 2). The eccentric member has a piston pin receiving opening which receives the piston pin. This piston pin receiving opening is provided so as to offset with respect to a swivel axis of the eccentric member. In such a variable length connecting rod, if changing the swivel position of the eccentric member, the effective length of the connecting rod can be changed accordingly.

### CITATION LIST

### Patent Literature

[PTL 1]

International Publication No. 2014/019683A

[PTL 2]

Japanese Patent Publication No. H03-242433A

[PTL 3]

Japanese Patent Publication No. 2011-196549A

### SUMMARY OF INVENTION

### Technical Problem

In this regard, PTL 1 discloses use of two piston mechanisms in order to make the eccentric member rotate. The cylinders of the two piston mechanisms are connected through a fluid path. Part of the hydraulic fluid flowing out from one cylinder flows into the other cylinder.

However, in the device described in PTL 1, along with operation of the piston mechanism, hydraulic fluid is fed to the piston mechanism and the fluid path between the piston mechanisms from the outside hydraulic fluid feed source. If hydraulic fluid is fed from the outside in this way, the greater the amount of feed or the faster the rate of feed, the more bubbles enters into the hydraulic fluid. If bubbles enter into the hydraulic fluid in this way, the piston mechanism unintentionally fluctuates.

Therefore, in consideration of the above issue, an object of the present invention is to provide a variable length connecting rod in which bubbles are kept from entering into a hydraulic fluid in a cylinder of a piston mechanism.

### Solution to Problem

To solve the above problem, the following inventions are provided.

(1) A variable length connecting rod enabling change of effective length, comprising: a connecting rod body having at its big end a crank receiving opening which receives a crank pin; an eccentric member which is attached at a small end in the opposite side to the big end to be able to swivel with respect to the connecting rod body in the circumferential direction of the small end and change an effective length of the variable length connecting rod if swiveled; a first piston mechanism which has a first cylinder provided in the connecting rod body and a first piston sliding in the first cylinder, and which is configured so that if hydraulic fluid is fed into the first cylinder, the eccentric member is swiveled in one direction to make the effective length longer; a second piston mechanism which has a second cylinder provided in the connecting rod body and a second piston sliding in the second cylinder, and which is configured so that if hydraulic fluid is fed into the second cylinder, the eccentric member is swiveled in an opposite direction to the one direction to make the effective length shorter; and a flow direction changing mechanism which can be switched between a first state where it prohibits flow of hydraulic fluid from the first cylinder to the second cylinder, but permits flow of hydraulic fluid from the second cylinder to the first cylinder and a second state where it permits flow of hydraulic fluid from the first cylinder to the second cylinder, but prohibits flow of hydraulic fluid from the second cylinder to the first cylinder, wherein the first piston mechanism and the second piston mechanism are formed so that a first cylinder volume defined by a stroke length of the first piston and a cross-sectional area of the first cylinder is equal to a second cylinder volume defined by a stroke length of the second piston and a cross-sectional area of the second cylinder.

(2) The variable length connecting rod according to above (1), wherein the cross-sectional area of the first cylinder is larger than the cross-sectional area of the second cylinder, and the first cylinder is provided at the big end side compared with the second cylinder.

(3) The variable length connecting rod according to above (1) or (2), wherein the eccentric member comprises: a sleeve which is received in a sleeve receiving opening formed at a small end of the connecting rod body to be able to swivel; a first arm extending from the sleeve to one side of the connecting rod body in the width direction; and a second arm extending from the sleeve to the other side of the connecting rod body in the width direction, the first arm is connected through a first connecting member to the first piston, aid second arm is connected through a second connecting member to the second piston, and a distance between a connecting point of the first connecting member to the first arm and a center axis of the sleeve is shorter than a distance between a connecting point of the second connecting member to the second arm and a center axis of the sleeve.

(4) The variable length connecting rod according to any one of above (1) to (3), wherein the first cylinder of the first piston mechanism and the second cylinder of the second piston mechanism are connected through the flow direction changing mechanism and fluid path, the variable length connecting rod further comprises a refill fluid path which communicates with the flow direction changing mechanism or fluid path between the first cylinder and the second cylinder, and hydraulic fluid is fed to the refill fluid path from the hydraulic fluid feed source.

(5) The variable length connecting rod according to any one of above (1) to (4), wherein the flow direction changing mechanism is switched between the first state and the second state by hydraulic pressure flowing through a hydraulic pressure feed fluid path connected to the hydraulic pressure feed source, and the flow direction changing mechanism is configured so as to become the second state where the effective length of the variable length connecting rod becomes shorter when hydraulic pressure is not being fed through the hydraulic pressure feed fluid path and so as to become the first state where the effective length of the variable length connecting rod becomes longer when hydraulic pressure is being fed through the hydraulic pressure feed fluid path.

(6) The variable length connecting rod according to any one of above (1) to (5), wherein the flow direction changing valve comprises: a switching pin arranged in the connecting rod body and able to move between a first position and a second position; and a check valve arranged in the switching pin, and the switching pin and check valve are configured so that when the switching pin is at the first position, due to the check valve, flow of hydraulic fluid from the first cylinder to the second cylinder is prohibited, but flow of hydraulic fluid from the second cylinder to the first cylinder is permitted; and when the switching pin is at the second position, due to the check valve, flow of hydraulic fluid from the first cylinder to the second cylinder is permitted, but flow of hydraulic fluid from the second cylinder to the first cylinder is prohibited.

(7) The variable length connecting rod according to above (6), wherein two the check valves are provided, and the switching pin and two check valves are configured so that when the switching pin is at the first position, due to one of the two check valves, flow of hydraulic fluid from the first cylinder to the second cylinder is prohibited, but flow of hydraulic fluid from the second cylinder to the first cylinder is permitted; and when the switching pin is at the second position, due to the other of the two check valves, flow of hydraulic fluid from the first cylinder to the second cylinder is permitted, but flow of hydraulic fluid from the second cylinder to the first cylinder is prohibited.

### Advantageous Effects of Invention

According to the present invention, there is provided a variable length connecting rod in which bubbles are kept from entering into a hydraulic fluid in a cylinder of a piston mechanism.

### BRIEF DESCRIPTION OF DRAWINGS

FIG. 1 is a schematic side cross-sectional view of a variable compression ratio internal combustion engine.

FIG. 2 is a perspective view which schematically shows a variable length connecting rod according to the present invention.

FIG. 3 is a cross-sectional side view which schematically shows a variable length connecting rod according to the present invention.

FIG. 4 is a schematic disassembled perspective view of the vicinity of a small end of a connecting rod body.

FIG. 5 is a schematic disassembled perspective view of the vicinity of a small end of a connecting rod body.

FIGS. 6A and 6B show cross-sectional side views which schematically show a variable length connecting rod according to the present invention.

FIG. 7 is a cross-sectional side view of a connecting rod, in which a region where a flow direction switching mechanism is provided is enlarged.

FIG. 8 is a cross-sectional view of a connecting rod, similar to FIG. 7, in which a region where a flow direction switching mechanism is provided is enlarged.

FIG. 9 is a schematic view which explains an operation of a flow direction switching mechanism when hydraulic pressure is supplied from a hydraulic pressure supply source to a switching pin.

FIG. 10 is a schematic view which explains an operation of a flow direction switching mechanism when hydraulic pressure is not supplied from a hydraulic pressure supply source to a switching pin.

### DESCRIPTION OF EMBODIMENTS

Below, an embodiment of the present invention will be explained in detail with reference to the drawings. Note that, in the following explanation, similar component elements will be assigned the same reference notations.

<Variable Compression Ratio Internal Combustion Engine>

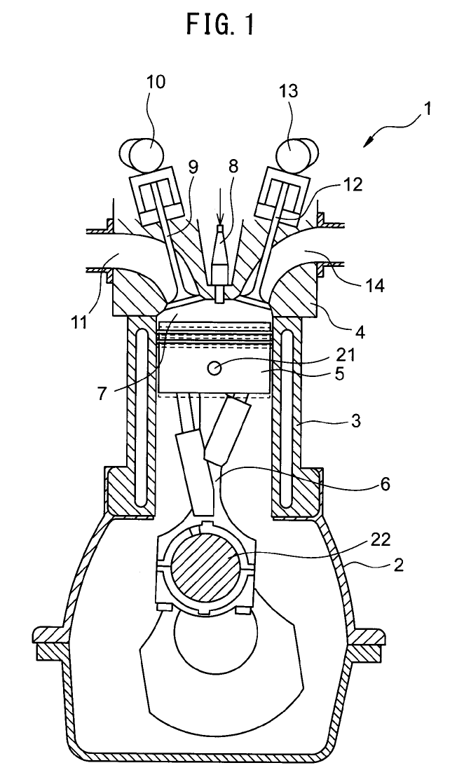

FIG. 1 is a side cross-sectional view of a variable compression ratio internal combustion engine according to the present invention.

Referring to FIG. 1, 1 indicates an internal combustion engine. The internal combustion engine 1 comprises a crankcase 2, cylinder block 3, cylinder head 4, piston 5, variable length connecting rod 6, combustion chamber 7, spark plug 8 arranged at the center of the top surface of the combustion chamber 7, intake valve 9, intake cam shaft 10, intake port 11, exhaust valve 12, exhaust cam shaft 13, and exhaust port 14.

The variable length connecting rod 6 is connected at a small end thereof by a piston pin 21 to the piston 5, and is connected at a big end thereof to a crank pin 22 of the crankshaft. The variable length connecting rod 6, as explained later, can change the distance from the axis of the piston pin 21 to the axis of the crank pin 22, that is, the effective length.

If the effective length of the variable length connecting rod 6 becomes longer, the length from the crank pin 22 to the piston pin 21 is longer, and therefore as shown by the solid line in the figure, the volume of the combustion chamber 7 when the piston 5 is at top dead center is smaller. On the other hand, even if the effective length of the variable length connecting rod 6 changes, the stroke length of the piston 5 reciprocating in the cylinder does not change. Therefore, at this time, the mechanical compression ratio at the internal combustion engine 1 is larger.

On the other hand, if the effective length of the variable length connecting rod 6 is shorter, the length from the crank pin 22 to the piston pin 21 is shorter, and therefore as shown by the broken line in the figure, the volume of the combustion chamber when the piston 5 is at top dead center is larger. However, as explained above, the stroke length of the piston 5 is constant. Therefore, at this time, the mechanical compression ratio at the internal combustion engine 1 is smaller.

<Configuration of Variable Length Connecting Rod>

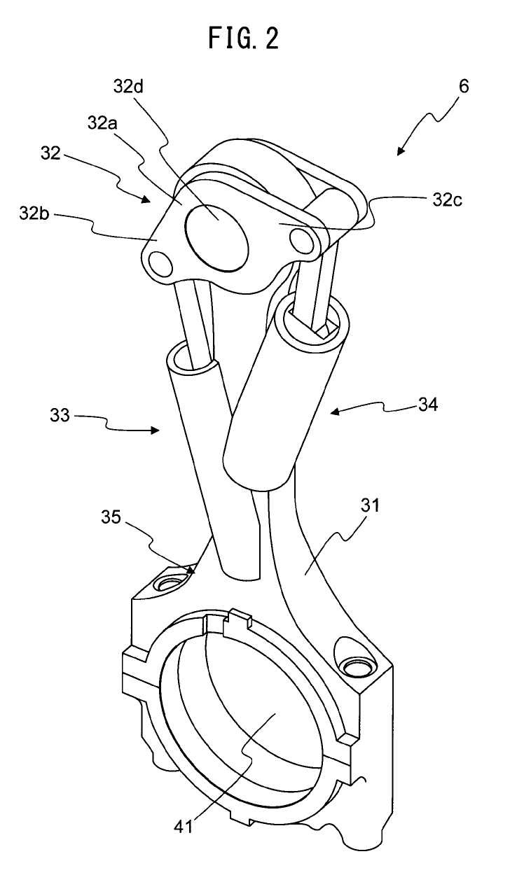

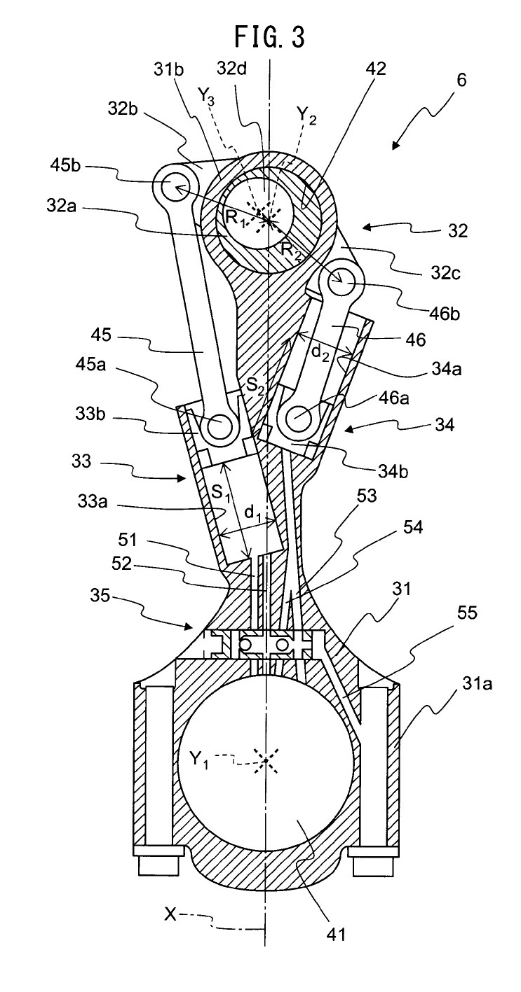

FIG. 2 is a perspective view which schematically shows the variable length connecting rod 6 according to the present invention, while FIG. 3 is a cross-sectional side view which schematically shows a variable length connecting rod 6 according to the present invention. As shown in FIG. 2 and FIG. 3, the variable length connecting rod 6 comprises a connecting rod body 31, an eccentric member 32 which is attached to the connecting rod body 31 to be able to swivel, a first piston mechanism 33 and second piston mechanism 34 which are provided at the connecting rod body 31, and a flow direction switching mechanism 35 which switches the flow of hydraulic fluid to these piston mechanisms 33 and 34.

First, the connecting rod body 31 will be explained. The connecting rod body 31 has at one end a crank pin receiving opening 41 which receives the crank pin 22 of the crankshaft, and has at the other end a sleeve receiving opening 42 which receives the sleeve of the later explained eccentric member 32. The crank pin receiving opening 41 is larger than the sleeve receiving opening 42, and therefore the end of the connecting rod body 31 of the side where the crank pin receiving opening 41 is provided, will be called the big end 31a, while the end of the connecting rod body 31 of the side where the sleeve receiving opening 42 is provided, will be called the small end 31b.

Note that, in this Description, an axis X extending between a center axis Y1 of the crank pin receiving opening 41 (that is, the axis of the crank pin 22 received in the crank pin receiving opening 41) and a center axis Y2 of the sleeve receiving opening 42 (that is, the axis of the sleeve received in the sleeve receiving opening 42) (FIG. 3), that is, the line passing through the center of the connecting rod body 31, will be called the “axis of the connecting rod 6”. Further, the length of the connecting rod in the direction perpendicular to the axis X of the connecting rod 6 and perpendicular to the center axis Y1 of the crank pin receiving opening 41 will be called the “width of the connecting rod”. In addition, the length of the connecting rod in the direction parallel to the center axis Y1 of the crank pin receiving opening 41 will be called the “thickness of the connecting rod”.

As will be understood from FIG. 2 and FIG. 3, the width of the connecting rod body 31 is narrowest at the intermediate part between the big end 31a and the small end 31b. Further, the width of the big end 31a is larger than the width of the small end 31b. On the other hand, the thickness of the connecting rod body 31 is substantially a constant thickness, except for the region at which the piston mechanisms 33, 34 are provided.

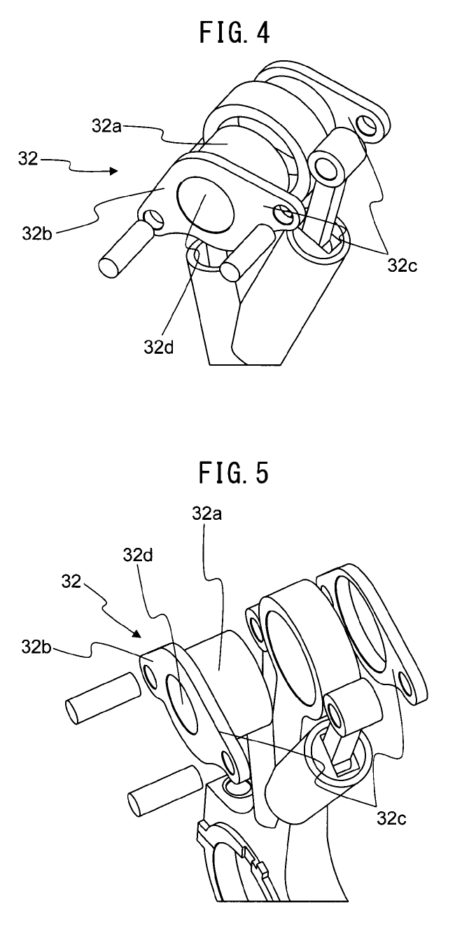

Next, the eccentric member 32 will be explained. FIG. 4 and FIG. 5 are schematic perspective views of the vicinity of the small end 31b of the connecting rod body 31. In FIG. 4 and FIG. 5, the eccentric member 32 is shown in the disassembled state. Referring to FIG. 2 to FIG. 5, the eccentric member 32 comprises: a cylindrical sleeve 32a received in a sleeve receiving opening 42 formed in the connecting rod body 31; a pair of first arms 32b extending from the sleeve 32a in one direction of the width direction of the connecting rod body 31; and a pair of second arms 32c extending from the sleeve 32a in the other direction of the width direction of the connecting rod body 31 (direction generally opposite to above one direction). The sleeve 32a can swivel in the sleeve receiving opening 42 in a circumferential direction thereof, and therefore the eccentric member 32 is attached to be able to swivel in the circumferential direction of the small end 31 with respect to the connecting rod body 31 in the small end 31b of the connecting rod body 31.

Further, the sleeve 32a of the eccentric member 32 has a piston pin receiving opening 32d for receiving a piston pin 21. This piston pin receiving opening 32d is formed in a cylindrical shape. The cylindrical piston pin receiving opening 32d has an axis Y3 parallel to the center axis Y2 of the cylindrical shape of the sleeve 32a, but is formed so as not to become coaxial with it. Therefore, the center of the piston pin receiving opening 32d is offset from the center of the cylindrical external shape of the sleeve 32a.

Therefore, if the eccentric member 32 swivels, the relative position of the piston pin receiving opening 32d in the sleeve receiving opening 42 changes. When the position of the piston pin receiving opening 32d is at the big end 31a side in the sleeve receiving opening 42, the effective length of the connecting rod 6 becomes shorter. Conversely, when the position of the piston pin receiving opening 32d is at the opposite side to the big end 31a side in the sleeve receiving opening 42, the effective length of the connecting rod becomes longer. Therefore, according to the present embodiment, by swiveling the eccentric member, the effective length of the connecting rod 6 changes.

Next, referring to FIG. 3, the first piston mechanism 33 will be explained. The first piston mechanism 33 has a first cylinder 33a formed in the connecting rod body 31 and a first piston 33b sliding in the first cylinder 33a. The first cylinder 33a is almost entirely or entirely arranged at the first arm 32b side from the axis X of the connecting rod 6. Further, the first cylinder 33a is arranged slanted by a certain extent of angle with respect to the axis X so that it sticks out in the width direction of the connecting rod body 31 the more to the small end 31b. Further, the first cylinder 33a is connected to the flow direction switching mechanism 35 through a first piston communicating fluid path 51 and a second piston communication fluid path 52.

The first piston 33b is connected with the first arm 32b of the eccentric member 32 through a first connecting member 45. The first piston 33b is connected by a pin 45a to the first connecting member 45 to be able to rotate. The first arm 32b is connected to the first connecting member 45 by a pin 45b to be able to rotate, at the end part opposite to the side connected to the sleeve 32a.

Next, the second piston mechanism 34 will be explained. The second piston mechanism 34 has a second cylinder 34a formed in the connecting rod body 31 and a second piston 34b sliding in the second cylinder 34a. The second cylinder 34a is almost entirely or entirely arranged at the second arm 32c side with respect to the axis X of the connecting rod 6. Further, the second cylinder 34a is arranged inclined from the axis X by a certain extent of angle so that it sticks out further in the width direction of the connecting rod body 31 the closer to the small end 31b. Further, the second cylinder 34a is communicated through a third piston communicating fluid path 53 and a fourth piston communicating fluid path 54 with the flow direction changing mechanism 35. In addition, in the present embodiment, the second cylinder 34a is provided at the small end 31b side compared with the first cylinder 33a.

The second piston 34b is connected through a second connecting member 46 to the second arm 32c of the eccentric member 32. The second piston 34b is connected by a pin 46a to the second connecting member 46 to be able to rotate. The second arm 32c is connected by a pin 46b to the second connecting member 46 to be able to rotate at the end part of the opposite side to the side connected to the sleeve 32a.

In this regard, the volume defined by the stroke length S₁ of the first piston 33b and the bore diameter d₁ of the first cylinder 33a (that is, the cross-sectional area of the first cylinder 33a) is referred to as the first cylinder volume V₁ (V₁=S₁·π·d₁²/4). Similarly, the volume defined by the stroke length S₂ of the second piston 34b and the bore diameter d₂ of the second cylinder 34a (that is, the cross-sectional area of the second cylinder 34a) is referred to as the second cylinder volume V₂ (V₂=S₂·π·d₂²/4). In the present embodiment, the first piston mechanism 33 and second piston mechanism 34 are formed so that the thus defined first cylinder volume V₁ and second cylinder volume V₂ are equal.

In addition, in the present embodiment, the bore diameter d₁ of the first cylinder 33a is larger than the bore diameter d₂ of the second cylinder 34a. That is, the cross-sectional area of the first cylinder 33a is larger than the cross-sectional area of the second cylinder 34a. Therefore, the stroke length S₁ of the first piston 33b is shorter than the stroke length S₂ of the second piston 34b so that the first cylinder volume V₁ and the second cylinder volume V₂ are equal.

In the present embodiment, the length of the first arm 32b of the eccentric member 32 and the length of the second arm 32c are different so that the stroke length S₁ of the first piston 33b is shorter than the stroke length S₂ of the second piston 34b. Specifically, these arms 32b, 32c are formed so that the length of the first arm 32b is shorter than the length of the second arm 32c. As a result, the distance R₁ between the connecting point of the first connecting member 45 with the first arm 32b (that is, the axis of the pin 45b) and the center axis Y₂ of the sleeve receiving opening 42 is shorter than the distance R₂ between the connecting point of the second connecting member 46 with the second arm 32c (that is, the axis of the pin 46b) and the center axis Y₂ of the sleeve receiving opening 42. Accordingly, the stroke length S₁ can be shorter than the stroke length S₂.

<Operation of Variable Length Connecting Rod>

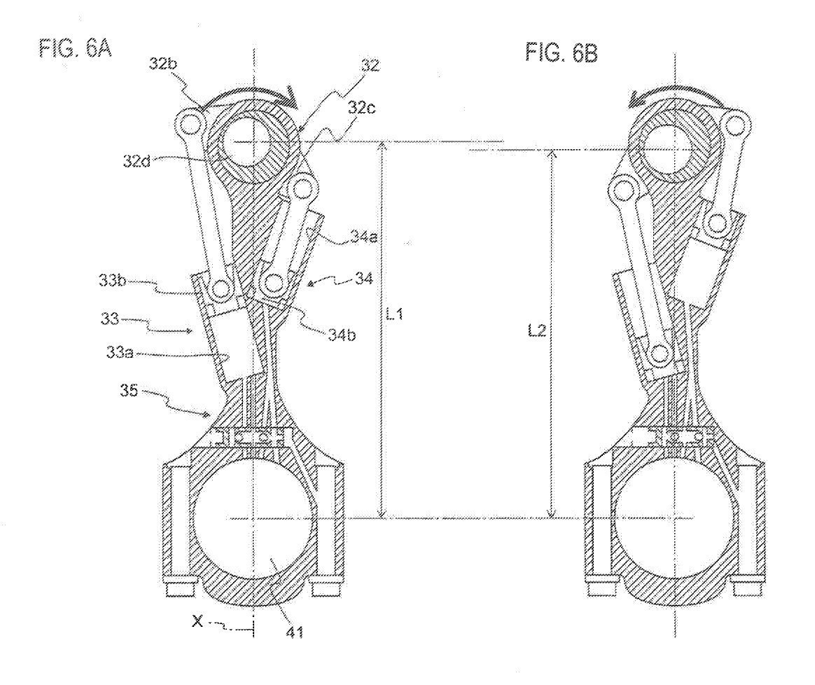

Next, referring to FIGS. 6A and 6B, the operation of the thus configured eccentric member 32, first piston mechanism 33, and second piston mechanism 34 will be explained. FIG. 6A shows the state where hydraulic fluid is fed to the first cylinder 33a of the first piston mechanism 33 and hydraulic fluid is not fed to the second cylinder 34a of the second piston mechanism 34. On the other hand, FIG. 6B shows the state where hydraulic fluid is not fed to the first cylinder 33a of the first piston mechanism 33 and hydraulic fluid is fed to the second cylinder 34a of the second piston mechanism 34.

In this regard, as explained later, the flow direction changing mechanism 35 can be switched between a first state where it prohibits the flow of hydraulic fluid from the first cylinder 33a to the second cylinder 34a and permits the flow of hydraulic fluid from the second cylinder 34a to the first cylinder 33a and a second state where it permits the flow of hydraulic fluid from the first cylinder 33a to the second cylinder 34a and prohibits the flow of hydraulic fluid from the second cylinder 34a to the first cylinder 33a.

When the flow direction changing mechanism 35 is in the first state where it prohibits flow of hydraulic fluid from the first cylinder 33a to the second cylinder 34a and permits flow of hydraulic fluid from the second cylinder 34a to the first cylinder 33a, as shown in FIG. 6A, hydraulic fluid is fed to the first cylinder 33a and hydraulic fluid is discharged from the second cylinder 34a. Therefore, the first piston 33b rises and the first arm 32b of the eccentric member 32 connected to the first piston 33b also rises. On the other hand, the second piston 34b descends and the second arm 32c connected to the second piston 34b also descends. As a result, in the example shown in FIG. 6A, the eccentric member 32 swivels in the arrow direction of the figure and as a result the position of the piston pin receiving opening 32d rises. Therefore, the length between the center of the crank receiving opening 41 and the center of the piston pin receiving opening 32d, that is, the effective length of the connecting rod 6, becomes longer and becomes L1 in the figure. That is, if hydraulic fluid is fed to the inside of the first cylinder 33a and hydraulic fluid is discharged from the second cylinder 34a, the effective length of the connecting rod 6 becomes longer.

On the other hand, if the flow direction changing mechanism 35 is in the second state where it permits the flow of hydraulic fluid from the first cylinder 33a to the second cylinder 34a and prohibits the flow of hydraulic fluid from the second cylinder 34a to the first cylinder 33a, as shown in FIG. 6B, hydraulic fluid is fed to the inside of the second cylinder 34a and hydraulic fluid is discharged from the first cylinder 33a. Therefore, the second piston 34b rises and the second arm 32c of the eccentric member 32 connected to the second piston 34b also rises. On the other hand, the first piston 33b descends and the first arm 32b connected to the first piston 33b also descends. As a result, in the example shown in FIG. 6B, the eccentric member 32 swivels in the arrow direction in the figure (direction opposite to arrow of FIG. 6A) and, as a result, the position of the piston pin receiving opening 32d descends. Therefore, the length between the center of the crank receiving opening 41 and the center of the piston pin receiving opening 32d, that is, the effective length of the connecting rod 6, becomes L2 shorter than L1 in the figure. That is, if hydraulic fluid is fed to the inside of the second cylinder 34a and hydraulic fluid is discharged from the first cylinder 33a, the effective length of the connecting rod 6 becomes shorter.

Therefore, in the connecting rod 6 according to the present embodiment, as explained above, the effective length of the connecting rod 6 can be switched between L1 and L2, by switching the flow direction changing mechanism 35 between the first state and the second state. As a result, in the internal combustion engine 1 using the connecting rod 6, it is possible to change the mechanical compression ratio.

In this regard, when the flow direction changing mechanism 35 is in the first state, basically hydraulic fluid is not fed from the outside. The first piston 33b and second piston 34b move to the positions shown in FIG. 6A and are maintained at these positions. This is because when the piston 5 reciprocates in the cylinder of the internal combustion engine 1 and an upward inertia force acts on the piston 5, the second piston 34b is pushed in, and accordingly, hydraulic fluid in the second cylinder 34a moves to the first cylinder 33a. On the other hand, when the piston 5 reciprocates in the cylinder of the internal combustion engine 1 and a downward inertial force acts on the piston 5 or when the air-fuel mixture in the combustion chamber 7 burns and a downward force acts on piston 5, the first piston 33b is tried to be pushed in. However, due to the flow direction changing mechanism 35, the flow of hydraulic fluid from the first cylinder 33a to the second cylinder 34a is prohibited, and therefore hydraulic fluid in the first cylinder 33a does not flow out and thus the first piston 33b is not pushed in.

On the other hand, even when the flow direction changing mechanism 35 is in the second state, basically hydraulic fluid is not fed from the outside. The first piston 33b and second piston 34b move to the positions shown in FIG. 6B and are maintained at those positions. This is because when the piston 5 reciprocates in the cylinder of the internal combustion engine 1 and a downward inertial force acts on the piston 5 or when the air-fuel mixture in the combustion chamber 7 burns and a downward force acts on the piston 5, the first piston 33b is pushed in, and accordingly, hydraulic fluid in the first cylinder 33a moves to the second cylinder 34a. On the other hand, when the piston 5 reciprocates in the cylinder of the internal combustion engine 1 and an upward inertia force acts on the piston 5, the second piston 34b is tried to be pushed in. However, due to the flow direction changing mechanism 35, the flow of hydraulic fluid from the second cylinder 34a to the first cylinder 33a is prohibited, and therefore hydraulic fluid in the second cylinder 34a does not flow out and therefore the second piston 34b is not pushed in.

<Action and Effect of Variable Length Connecting Rod>

In the present embodiment, the first piston mechanism 33 and second piston mechanism 34 are formed so that the first cylinder volume V₁ and the second cylinder volume V₂ are equal to each other. As a result, when the flow direction changing mechanism 35 is in the first state, all of the hydraulic fluid discharged from the second cylinder 34a is fed to the inside of the first cylinder 33a. Similarly, when the flow direction changing mechanism 35 is in the second state, all of the hydraulic fluid discharged from the first cylinder 33a is fed to the second cylinder 34a. Therefore, according to the present embodiment, basically the piston mechanisms 33, 34 can be operated and therefore the eccentric member 32 can be swiveled, without feeding hydraulic fluid from the outside.

In this regard, when feeding hydraulic fluid from the outside, sometimes bubbles, etc., enter into the fed hydraulic fluid. If bubbles enter into the hydraulic fluid in this way, when the first piston 33b or second piston 34b receives force from the outside (inertial force or force accompanying combustion of the air-fuel mixture), the bubbles in the cylinders 33a, 33b are compressed and the position of the first piston 33b or second piston 34b changes. As a result, the effective length of the connecting rod 6 becomes a value different from the target value and the mechanical compression ratio also changes.

As opposed to this, in the present embodiment, it is possible to swivel the eccentric member 32 without feed of hydraulic fluid from the outside. Therefore, it is possible to keep the mechanical compression ratio from changing unintentionally along with swiveling of the eccentric member 32 due to bubbles entering into the hydraulic pressure mechanism.

Further, as explained above, a downward force acts on the piston 5 due to the inertial force due to reciprocating motion of the piston 5 and combustion of the air-fuel mixture in the combustion chamber 7. Among these, the downward force occurring due to combustion is extremely large. Therefore, if the air-fuel mixture is burned in the combustion chamber 7, a large downward force is applied to the piston 5. Accordingly, the eccentric member 32 tries to swivel in the direction shown by the arrow in FIG. 6B. Therefore, at this time, a large force is applied to the first piston mechanism 33 in the contraction direction.

As opposed to this, in the present embodiment, the first piston mechanism 33 and second piston mechanism 34 are formed so that the cross-sectional area of the first cylinder 33a is larger than the cross-sectional area of the second cylinder 34a. Therefore, even if a large force acts on the first piston 33b of the first piston mechanism 33 along with combustion of the air-fuel mixture, the rise in the hydraulic pressure along with this is suppressed. Therefore, leakage of the hydraulic fluid and breakdown of the hydraulic pressure mechanism, etc., are suppressed.

Further, in the present embodiment, the first cylinder 33a is provided at the big end 31a side compared with the second cylinder 34a. In this regard, the width of the connecting rod 6 when the first cylinder 33a and second cylinder 34a are not provided is larger at the big end 31a side. In the present embodiment, by arranging the first cylinder 33a at the big end 31a side, it becomes possible to arrange the first cylinder 33a with a large cross-sectional area at the large width location of the connecting rod 6. As a result, it is possible to suppress a drop in strength of the connecting rod 6 due to provision of the cylinders 33a, 34a.

<Constitution of Flow Direction Changing Mechanism>

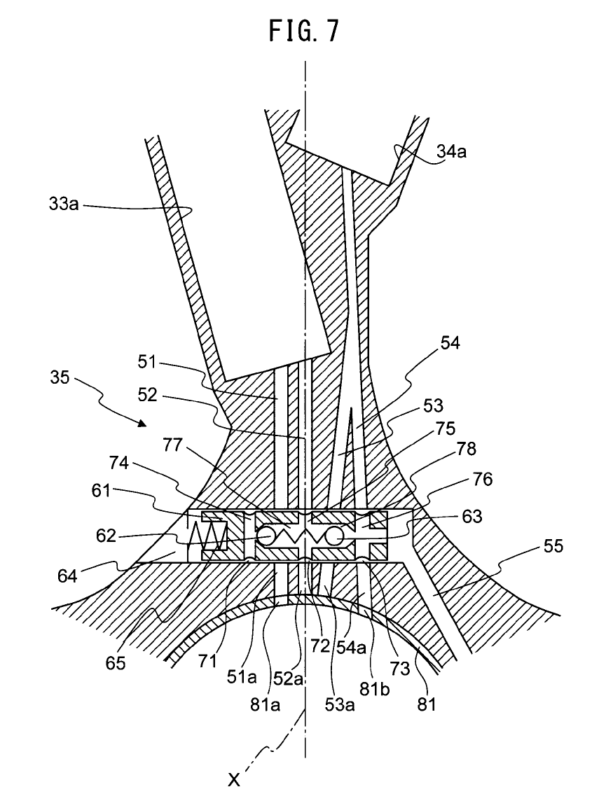

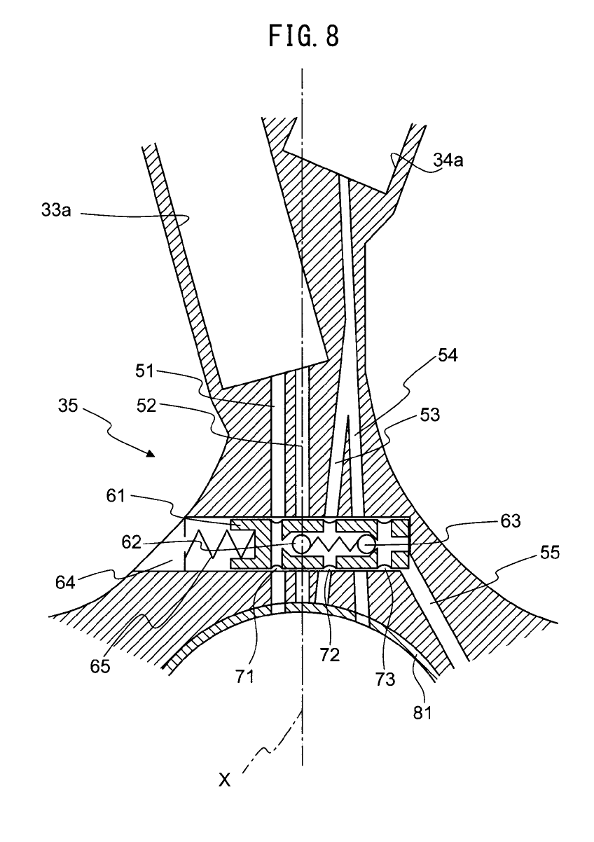

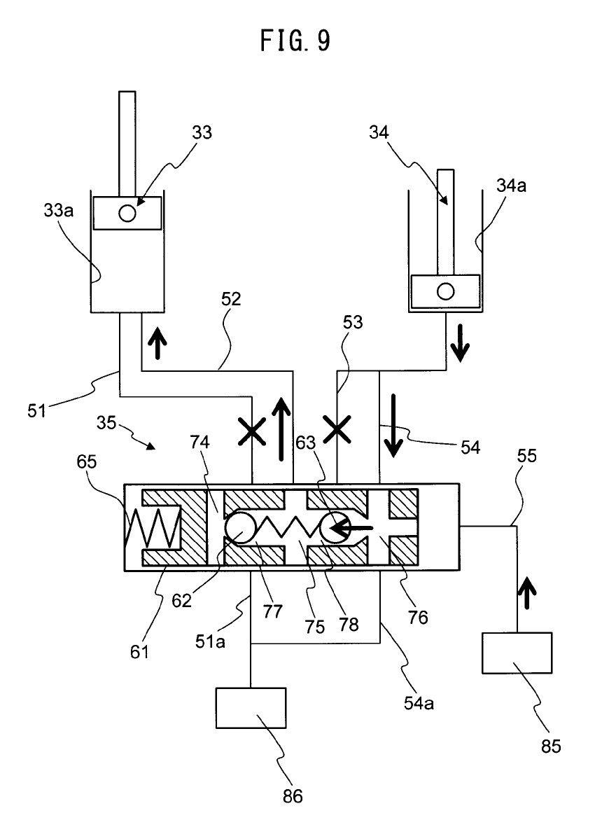

Next, referring to FIG. 7 and FIG. 8, the configuration of the flow direction changing mechanism 35 will be explained. FIG. 7 and FIG. 8 is a cross-sectional side view of the connecting rod, in which a region where the flow direction changing mechanism 35 is provided, is enlarged. FIG. 7 shows the state where the switching pin is pushed against a biasing spring by hydraulic pressure, while FIG. 8 shows the state where the switching pin is biased by the biasing spring. As explained above, the flow direction changing mechanism 35 is a mechanism switched between a first state where it prohibits the flow of hydraulic fluid from the first cylinder 33a to the second cylinder 34a and permits the flow of hydraulic fluid from the second cylinder 34a to the first cylinder 33a and a second state where it permits the flow of hydraulic fluid from the first cylinder 33a to the second cylinder 34a and prohibits the flow of hydraulic fluid from the second cylinder 34a to the first cylinder 33a.

As shown in FIG. 7 and FIG. 8, the flow direction changing mechanism 35 comprises a switching pin 61 and two check valves 62, 63 provided in a fluid path in the switching pin 61. The switching pin 61 is arranged between the first and second cylinders 33a and 34a and the crank receiving opening 41 in the axial X-direction of the connecting rod body 31.

The switching pin 61 is formed in a substantially cylindrical shape and is held in a cylindrical pin holding space 64. In the present embodiment, the pin holding space 64 is formed so that its axis extends in the width direction of the connecting rod 6 (direction perpendicular to axis X of connecting rod 6 and perpendicular to center axis Y₁ of crank receiving opening 41). The switching pin 61 can slide in the pin holding space 64 in the direction in which the pin holding space 64 extends. Therefore, the switching pin 61 is arranged in the connecting rod body 31 so that the operating direction is the width direction of the connecting rod 6.

Note that, in the illustrated example, the pin holding space 64 is formed as a pin holding hole closed at one end in the width direction (right side in figure) and opened at the other end in the width direction (left side in figure). Therefore, at the time of production, the switching pin 61 is inserted from the open end to the inside of the pin holding space 64.

Further, a biasing spring 65 is held in the pin holding space 64. Due to this biasing spring 65, the switching pin 61 is biased in the width direction of the connecting rod body 31. In particular, in the example shown in FIG. 7 and FIG. 8, the switching pin 61 is biased toward the closed end part of the pin holding space 64.

The switching pin 61 has three circumferential grooves 71, 72, and 73 extending in the circumferential direction. These circumferential grooves 71, 72, and 73 are separated at certain intervals in the longitudinal direction of the switching pin 61. These circumferential grooves 71, 72, and 73 are respectively communicated with passing fluid paths 74, 75, and 76 extending through the switching pin 61 in the direction perpendicular to the longitudinal direction of the switching pin 61. The first passing fluid path 74 arranged at one side of the switching pin 61 in the longitudinal direction is communicated through the first communicating fluid path 77 with the center second passing fluid path 75. Similarly, the third passing fluid path 76 arranged at the other side of the switching pin 61 in the longitudinal direction is communicated through the second communicating fluid path 78 with the center second passing fluid path 75.

In the first communicating fluid path 77, the first check valve 62 is arranged, while in the second communicating fluid path 78, the second check valve 63 is arranged. These check valves 62, 63 are configured to permit the flow from the primary side to the secondary side and prohibit the flow from the secondary side to the primary side.

The first check valve 62 is arranged so that the first passing fluid path 74 is in the primary side and the second passing fluid path 75 is in the secondary side. Therefore, the first check valve 62 can be said to be configured to permit the flow of hydraulic fluid from the first passing fluid path 74 to the second passing fluid path 75, but prohibit the flow of hydraulic fluid from the second passing fluid path 75 to the first passing fluid path 74. Similarly, the second check valve 63 is arranged so that the third passing fluid path 76 is in the primary side and the second passing fluid path 75 is in the secondary side. Therefore, the second check valve 63 can be said to be configured to permit the flow of hydraulic fluid from the third passing fluid path 76 to the second passing fluid path 75, but prohibits the flow of hydraulic fluid from the second passing fluid path 75 to the third passing fluid path 76.

The pin holding space 64 is communicated through the first piston communicating fluid path 51 and second piston communicating fluid path 52 to the bottom part of the first cylinder 33a. The communicating part of the first piston communicating fluid path 51 with the pin holding space 64 is separated from the communicating part of the second piston communicating fluid path 52 with the pin holding space 64 by a certain distance in the width direction of the connecting rod body 31. Further, the pin holding space 64 is communicated through the third piston communicating fluid path 53 and fourth piston communicating fluid path 54 to the bottom part of the second cylinder 34a. The communicating part of the third piston communicating fluid path 53 with the pin holding space 64 is separated from the communicating part of the fourth piston communicating fluid path 54 with the pin holding space 64 by the above certain distance in the width direction of the connecting rod body 31.

In addition, the distance in the width direction of the connecting rod body 31 between the communicating part of the first piston communicating fluid path 51 with the pin holding space 64 and the communicating part of the third piston communicating fluid path 53 with the pin holding space 64 is equal to the distance in the longitudinal direction between the first circumferential groove 71 and second circumferential groove 72 of the switching pin 61. Further, the distance in the width direction of the connecting rod body 31 between the communicating part of the second piston communicating fluid path 52 to the pin holding space 64 and the communicating part of the fourth piston communicating fluid path 54 to the pin holding space 64 is equal to the distance in the longitudinal direction between the second circumferential groove 72 and third circumferential groove 73 of the switching pin 61.

Note that, the piston communicating fluid paths 51 to 54 are formed by drilling, etc., from the crank receiving opening 41. Therefore, at the crank receiving opening 41 sides of the piston communicating fluid paths 51 to 54, extended fluid paths 51a to 54a coaxial with these piston communicating fluid paths 51 to 54 respectively are formed. In other words, the piston communicating fluid paths 51 to 54 are formed so that the crank receiving opening 41 is positioned on the extensions. Among these extended fluid paths 51a to 54a, the second extended fluid path 52a and third extended fluid path 53a positioned on the extensions of the second piston communicating fluid path 52 and third piston communicating fluid path 53 are closed for example by bearing metal 81 provided in the crank receiving opening 41.

On the other hand, the first extended fluid path 51a and the fourth extended fluid path 54a positioned on extensions of the first piston communicating fluid path 51 and the fourth piston communicating fluid path 54 are communicated with an opening part 81a and an opening part 81b formed in the bearing metal 81, respectively. These opening parts 81a, 81b are communicated through a fluid path (not shown) formed in the crank pin 22 to an outside hydraulic fluid feed source. As a result, the first extended fluid path 51a and fourth extended fluid path 54a are formed as refill fluid paths for feeding hydraulic fluid from the hydraulic fluid feed source to the flow direction changing mechanism 35 or the fluid path between first cylinder 33a and second cylinder 34a.

Further, in the connecting rod body 31, a hydraulic pressure feed fluid path 55 for feeding hydraulic pressure to the switching pin 61 is formed. The hydraulic pressure feed fluid path 55 is communicated with the pin holding space 64 at the end opposite from the end at which the biasing spring 65 is provided. The hydraulic pressure feed fluid path 55 is formed so as to be communicated with the crank receiving opening 41 and is communicated through a fluid path (not shown) formed in the crank pin 22 to the outside hydraulic pressure feed source.

As a result, if the hydraulic pressure feed source feeds hydraulic pressure through the hydraulic pressure feed fluid path 55 to the pin holding space 64, as shown in FIG. 7, the switching pin 61 is moved against the biasing force of the biasing spring 65 (left direction in figure). On the other hand, when hydraulic pressure is not being fed to the pin holding space 64 from the hydraulic pressure feed source to the hydraulic pressure feed fluid path 55, as shown in FIG. 8, the switching pin 61 is moved by the biasing force of the biasing spring 65 (right direction in figure). As a result, the switching pin 61 is moved between the first position shown in FIG. 7 and the second position shown in FIG. 8 due to the feed of hydraulic pressure from the hydraulic pressure feed source.

<Operation of Flow Direction Changing Mechanism>

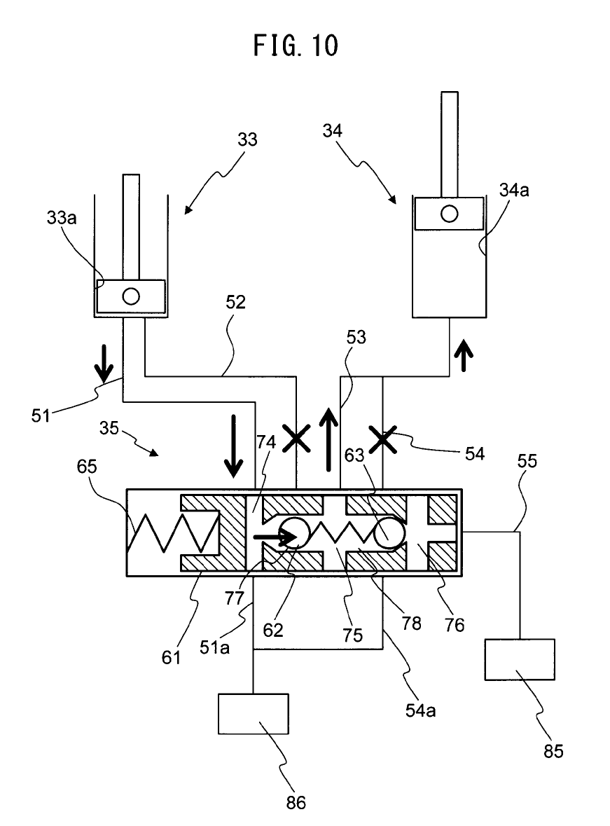

Next, referring to FIG. 9 and FIG. 10, operation of the flow direction changing mechanism 35 will be explained. FIG. 9 is a schematic view explaining the operation of the flow direction changing mechanism 35 when hydraulic pressure is fed from the hydraulic pressure feed source 85 to the switching pin 61. FIG. 10 is a view for explaining the operation of the flow direction changing mechanism 35 when the hydraulic pressure feed source 85 feeds hydraulic pressure.

As shown in FIG. 9, when hydraulic fluid is being fed from the hydraulic pressure feed source 85, the switching pin 61 is positioned at the first position to which it has moved against the biasing force by the biasing spring 65. As a result, the second piston communicating fluid path 52 is communicated with the second passing fluid path 75 of the switching pin 61, while the fourth piston communicating fluid path 54 is communicated with the third passing fluid path 76 of the switching pin 61. On the other hand, the first piston communicating fluid path 51 and the third piston communicating fluid path 53 are shut by the switching pin 61.

A second check valve 63 is arranged in the second communicating fluid path 78 between the second passing fluid path 75 and the third passing fluid path 76. The second check valve 63, as explained above, is configured to permit the flow of hydraulic fluid from the third passing fluid path 76 to the second passing fluid path 75, but prohibit the flow of hydraulic fluid from the second passing fluid path 75 to the third passing fluid path 76. Therefore, due to the second check valve 63, the flow of hydraulic fluid from the fourth piston communicating fluid path 54 to the second piston communicating fluid path 52 is permitted and the reverse flow is prohibited.

As a result, in the state shown in FIG. 9, the hydraulic fluid in the second cylinder 34a can be fed through the fluid path, in the order of the fourth piston communicating fluid path 54, third passing fluid path 76, second communicating fluid path 78, and second piston communicating fluid path 52, to the first cylinder 33a. However, the hydraulic fluid in the first cylinder 33a cannot be fed to the second cylinder 34a. Therefore, as shown in FIG. 9, when hydraulic pressure is fed from the hydraulic pressure feed source 85, due to the action of the second check valve 63, the flow direction changing mechanism 35 can be said to be in a first state where it prohibits the flow of hydraulic fluid from the first cylinder 33a to the second cylinder 34a and permits the flow of hydraulic fluid from the second cylinder 34a to the first cylinder 33. As a result, as explained above, the first piston 33b rises and the second piston 34b descends, and therefore the effective length of the connecting rod 6 becomes longer as shown in FIG. 6A by L1.

On the other hand, as shown in FIG. 10, when the hydraulic pressure feed source 85 feeds hydraulic pressure, the switching pin 61 is positioned at the second position biased by the biasing spring 65. As a result, the first piston communicating fluid path 51 is communicated with the first passing fluid path 74 of the switching pin 61, while the third piston communicating fluid path 53 is communicated with the second passing fluid path 75 of the switching pin 61. On the other hand, the second piston communicating fluid path 52 and the fourth piston communicating fluid path 54 are shut by the switching pin 61.

The first check valve 62 is arranged in the first communicating fluid path 77 between the first passing fluid path 74 and the second passing fluid path 75. The first check valve 62, as explained above, is configured to permit the flow of hydraulic fluid from the first passing fluid path 74 to the second passing fluid path 75, but prohibit the flow of hydraulic fluid from the second passing fluid path 75 to the first passing fluid path 74. Therefore, due to the first check valve 62, flow of hydraulic fluid from the first piston communicating fluid path 51 to the third piston communicating fluid path 53 is permitted and the reverse flow is prohibited.

As a result, in the state shown in FIG. 10, the hydraulic fluid in the first cylinder 33a can be fed through the fluid path, in the order of the first piston communicating fluid path 51, first passing fluid path 74, first communicating fluid path 77, and third piston communicating fluid path 53, to the second cylinder 34a. However, the hydraulic fluid in the second cylinder 34a cannot be fed to the first cylinder 33a. Therefore, as shown in FIG. 10, when the hydraulic pressure feed source 85 is not feeding hydraulic pressure, the flow direction changing mechanism 35 can be said to be in a second state where, due to the action of the first check valve 62, it permits the feed of hydraulic fluid from the first cylinder 33a to the second cylinder 34a and prohibits the flow of hydraulic fluid from the second cylinder 34a to the first cylinder 33a. As a result, as explained above, the first piston 33b descends and the second piston 34b rises, and therefore the effective length of the connecting rod 6 becomes shorter such as shown in FIG. 6B by L2.

Further, in the present embodiment, as explained above, the hydraulic fluid passes back and forth between the first cylinder 33a of the first piston mechanism 33 and the second cylinder 34a of the second piston mechanism 34. Therefore, basically, there is no need to feed hydraulic fluid from the outside of the first piston mechanism 33, second piston mechanism 34, and flow direction changing mechanism 35. However, the hydraulic fluid can leak to the outside from the seal, etc., provided with these mechanisms 33, 34, and 35. When such leakage of hydraulic fluid occurs, the fluid has to be refilled from the outside.

As opposed to this, in the present embodiment, when the flow direction changing mechanism 35, as shown in FIG. 9, is in the first state, the fourth extended fluid path 54a functioning as the refill fluid path is communicated with the primary side of the second check valve 63, that is, the third passing fluid path 76. Accordingly, when the flow direction changing mechanism 35 is in the first state, the primary side of the second check valve 63 is ordinarily or periodically communicated with the hydraulic fluid feed source 86. Therefore, when the flow direction changing mechanism 35 is in the first state, even when hydraulic fluid leaks from the piston mechanisms 33, 34 or the flow direction changing mechanism 35, hydraulic fluid can be refilled.

Similarly, when the flow direction changing mechanism 35, as shown in FIG. 10, is in the second state, a first extended fluid path 51a functioning as a refill fluid path is communicated with the primary side of the first check valve 62, that is, first passing fluid path 74. Accordingly, when the flow direction changing mechanism 35 is in the second state, the primary side of the first check valve 62 is ordinarily or periodically communicated with the hydraulic fluid feed source 86. Therefore, when the flow direction changing mechanism 35 is in the second state, even if hydraulic fluid leaks out from the piston mechanisms 33, 34 or flow direction changing mechanism 35, hydraulic fluid can be refilled.

<Action and Effect of Flow Direction Changing Mechanism>

In the present embodiment, the switching of the flow of the hydraulic fluid between the piston mechanisms 33, 34 is performed by the switching pin 61 of the flow direction changing mechanism 35. The switching pin 61 is held in the pin holding space 64 formed in the connecting rod body 31 and is driven by hydraulic pressure. Therefore, there is no longer a need to make the switching pin 61 stick out from the side surface of the connecting rod body 31 to the outside and there is no longer a need to provide another switching mechanism at the outside of the connecting rod 6 for making the switching pin 61 operate. Therefore, the flow direction changing mechanism 35 can be a simple, compact mechanism.

Further, in the flow direction changing mechanism 35 of the present embodiment, only a single switching pin 61 is used. Therefore, compared with when using a plurality of switching pins or actuating parts, the connecting rod 6 can be easily produced.

Furthermore, according to the present embodiment, the flow direction changing mechanism 35 is configured so that when the hydraulic pressure feed source 85 is not feeding hydraulic pressure to the switching pin 61, the first state is entered where the effective length of the connecting rod 6 becomes shorter, while when the hydraulic pressure feed source 85 is feeding hydraulic pressure to the switching pin 61, the second state is entered where the effective length of the connecting rod 6 becomes longer. Accordingly, for example, when breakdown at the hydraulic pressure feed source 85, etc., causes the hydraulic pressure to be unable to be fed any longer, the effective length of the connecting rod 6 can be kept short and therefore the mechanical compression ratio can be maintained low. If maintaining the mechanical compression ratio high, the output of the internal combustion engine is restricted, therefore, according to the present embodiment, it becomes possible to keep the output of the internal combustion engine from being limited at the time of breakdown of the hydraulic pressure feed source 85.

### REFERENCE SIGNS LIST

1 internal combustion engine

6 connecting rod

21 piston pin

22 crank pin

31 connecting rod body

32 eccentric member

33 first piston mechanism

34 second piston mechanism

35 flow direction changing mechanism

51 first piston communicating fluid path

52 second piston communicating fluid path

53 third piston communicating fluid path

54 fourth piston communicating fluid path

61 switching pins

62 first check valve

63 second check v

1. A variable length connecting rod enabling change of effective length, comprising:
a connecting rod body having at its big end a crank receiving opening which receives a crank pin;
an eccentric member which is attached at a small end in the opposite side to said big end to be able to swivel with respect to said connecting rod body in the circumferential direction of said small end and change an effective length of said variable length connecting rod if swiveled; a first piston mechanism which has a first cylinder provided in said connecting rod body and a first piston sliding in said first cylinder, and which is configured so that if hydraulic fluid is fed into said first cylinder, said eccentric member is swiveled in one direction to make said effective length longer;
a second piston mechanism which has a second cylinder provided in said connecting rod body and a second piston sliding in said second cylinder, and which is configured so that if hydraulic fluid is fed into said second cylinder, said eccentric member is swiveled in an opposite direction to said one direction to make said effective length shorter; and a flow direction changing mechanism which can be switched between a first state where it prohibits flow of hydraulic fluid from said first cylinder to said second cylinder, but permits flow of hydraulic fluid from said second cylinder to said first cylinder and a second state where it permits flow of hydraulic fluid from said first cylinder to said second cylinder, but prohibits flow of hydraulic fluid from said second cylinder to said first cylinder,
wherein said first piston mechanism and said second piston mechanism are formed so that a first cylinder volume defined by a stroke length of said first piston and a cross-sectional area of said first cylinder is equal to a second cylinder volume defined by a stroke length of said second piston and a cross-sectional area of said second cylinder, said flow direction changing mechanism is switched between said first state and said second state by hydraulic pressure flowing through a hydraulic pressure feed fluid path connected to the hydraulic pressure feed source, and
said flow direction changing mechanism is configured so as to become said second state where the effective length of said variable length connecting rod becomes shorter when hydraulic pressure is not being fed through said hydraulic pressure feed fluid path and so as to become said first state where the effective length of said variable length connecting rod becomes longer when hydraulic pressure is being fed through said hydraulic pressure feed fluid path.

2. The variable length connecting rod according to claim 1, wherein
said cross-sectional area of said first cylinder is larger than said cross-sectional area of said second cylinder, and
said first cylinder is provided at the big end side compared with said second cylinder.

3. The variable length connecting rod according to claim 1, wherein
said eccentric member comprises: a sleeve which is received in a sleeve receiving opening formed at a small end of said connecting rod body to be able to swivel; a first arm extending from said sleeve to one side of said connecting rod body in the width direction; and a second arm extending from said sleeve to the other side of said connecting rod body in the width direction,
said first arm is connected through a first connecting member to said first piston,
said second arm is connected through a second connecting member to said second piston, and
a distance between a connecting point of said first connecting member to said first arm and a center axis of said sleeve is shorter than a distance between a connecting point of said second connecting member to said second arm and a center axis of said sleeve.

4. The variable length connecting rod according to claim 1, wherein
said first cylinder of said first piston mechanism and said second cylinder of said second piston mechanism are connected through said flow direction changing mechanism and fluid path,
said variable length connecting rod further comprises a refill fluid path which communicates with said flow direction changing mechanism or fluid path between said first cylinder and said second cylinder, and hydraulic fluid is fed to said refill fluid path from a hydraulic fluid feed source.

5. (canceled)

6. The variable length connecting rod according to claim 1, wherein
said flow direction changing mechanism comprises: a switching pin arranged in said connecting rod body and able to move between a first position and a second position; and a check valve arranged in said switching pin, and
said switching pin and check valve are configured so that when said switching pin is at said first position, due to said check valve, flow of hydraulic fluid from said first cylinder to said second cylinder is prohibited, but flow of hydraulic fluid from said second cylinder to said first cylinder is permitted; and
when said switching pin is at said second position, due to said check valve, flow of hydraulic fluid from said first cylinder to said second cylinder is permitted, but flow of hydraulic fluid from said second cylinder to said first cylinder is prohibited.

7. The variable length connecting rod according to claim 6, wherein
two said check valves are provided, and
said switching pin and two check valves ate configured so that when said switching pin is at said first position, due to one of said two check valves, flow of hydraulic fluid from said first cylinder to said second cylinder is prohibited, but flow of hydraulic fluid from said second cylinder to said first cylinder is permitted; and
when said switching pin is at said second position, due to the other of said two check valves, flow of hydraulic fluid from said first cylinder to said second cylinder is permitted, but flow of hydraulic fluid from said second cylinder to said first cylinder is prohibited.
